(19) United States
(12) Patent Application Publication
(10) Pub. No.: US 2023/0157274 A1
(43) Pub. Date: May 25, 2023

(54) NUCLEIC ACID AND CELL PRESERVATIVE COMPOSITIONS AND METHODS OF USE

(71) Applicant: SIO2 Medical Products, Inc., Auburn, AL (US)

(72) Inventors: Joseph Piccirilli, Chicago, IL (US); Christopher Weikart, Auburn, AL (US); Alexander M. Klibanov, Auburn, AL (US); Tia Hexom, Auburn, AL (US); Brandy Nunez, Fullerton, CA (US)

(21) Appl. No.: 17/920,271

(22) PCT Filed: Apr. 15, 2021
(86) PCT No.: PCT/US2021/027573

§ 371 Date: Oct. 20, 2022

Related U.S. Application Data
(63) Continuation-in-part of application No. PCT/US2021/012844, filed on Jan. 8, 2021.
(60) Provisional application No. 63/012,637, filed on Apr. 20, 2020.
(60) Provisional application No. 62/959,818, filed on Jan. 10, 2020.
(60) Provisional application No. 63/011,468, filed on Apr. 17, 2020.

(51) Int. Cl. A01N 1/02

(52) U.S. Cl. CPC A01N 1/0226; A01N 1/0231

(57) ABSTRACT

This disclosure is directed to nucleic acid and cell preservative compositions. Methods of preserving nucleic acids and/or cells in a blood or other biological sample, and kits for preserving nucleic acids and/or cells in a blood or other biological sample are also described.

### CROSS-REFERENCE TO RELATED APPLICATION

This application claims the benefit of, priority to, and incorporates by reference in their entirety International Application No. PCT/US2021/012844, filed Jan. 8, 2021, and U.S. Provisional Application No. 63/012,637, filed Apr. 20, 2020.

### FIELD OF THE DISCLOSURE

The disclosure relates to compositions, methods and kits for preserving nucleic acids and/or cells in blood or other biological samples.

### BACKGROUND OF THE DISCLOSURE

A number of nucleic acid-based tests are used to analyze variations in the sequence, structure or expression of DNA and RNA for a variety of diagnostic purposes. Indeed, nucleic acids are common examination targets for non-invasive biomedical studies. However, after a biological sample has been collected, the nucleic acids within that sample, e.g., RNA and DNA, whether cellular/genomic or cell free, begin to degrade. Furthermore, gene induction and the degradation of gene transcripts begin occurring within minutes of blood or other biological sample collection, making it difficult to accurately analyze the gene expression of the sample at the time it is collected. Moreover, in general, the fresher the blood or other biological sample, the better the quality of the nucleic acids of that sample will be. This presents a problem when the nucleic acids of a subject's blood or biological sample are to be analyzed. It is often the case that blood and other biological samples are collected at a different location and at a very different time than where and when they are analyzed. For this reason, after blood or other biological samples are collected, they need to be stored and transported before they can be analyzed. Due to the rapid degradation of nucleic acids that occurs in blood and other biological samples after they are collected, there is a need for a method to preserve the nucleic acids that are present in samples in order to ensure that the nucleic acids of the samples are of high quality at the time they are analyzed.

In the case of cell free nucleic acids in a blood or other biological sample, the different location and timing of collection and analysis present an additional problem: cell lysis. Cell lysis in the collected sample may lead to the contamination of the cell free nucleic acid profile with cellular nucleic acids, making it difficult to accurately analyze the cell free nucleic acids in the blood or biological sample. Cell lysis begins to occur soon after blood or other biological samples have been collected. This presents a problem when the samples need to be stored for an extended period of time prior to being analyzed. Thus, there is a further need to preserve blood and other biological samples such that the cell free profile of its nucleic acids is maintained.

Similarly, for diagnostic applications that are based on the detection or analysis of cells, e.g., circulating tumor cells in a biological sample, the preservation of those cells in their intact form is important.

### SUMMARY OF THE DISCLOSURE

In a first aspect, the disclosure is directed to a nucleic acid and cell preservative composition comprising:

a. one or more osmotic agents, the one or more osmotic agents being present in an amount sufficient to produce a hypertonic or isotonic solution;

b. one or more enzyme inhibitors;

c. optionally one or more metabolic inhibitors;

d. optionally a plasma expander; and

e. a Ficoll;

wherein the composition does not include glycerol or mannitol.

In a second aspect, the disclosure is directed to a nucleic acid and cell preservative composition comprising:

a. one or more osmotic agents, the one or more osmotic agents being present in an amount sufficient to produce a hypertonic solution;

b. one or more enzyme inhibitors;

c. optionally one or more metabolic inhibitors;

d. optionally a plasma expander; and

e. one or more cell surface remodeling polymers.

In a third aspect, the disclosure is directed to a nucleic acid and cell preservative composition comprising:

a. optionally one or more osmotic agents;

b. one or more enzyme inhibitors;

c. optionally one or more metabolic inhibitors;

d. optionally a plasma expander;

e. optionally one or more cell surface remodeling polymers;

f. optionally one or more agents selected from the group consisting of hydroxyethylstarch, a polymer of N-vinylpyrollidone (NVP), a Ficoll, a protein colloid, a non-protein synthetic colloid, ethylene diol, propylene glycol, a water-soluble polymer and carboxymethylcellulose or a salt thereof; and

g. optionally polypropylene glycol (PPG); wherein at least one cell surface remodeling polymer (e) or agent (f) is present, provided that when a cell surface remodeling polymer (e) is not present, the one or more optional osmotic agents, if present, is/are present in an amount of about 0.1% to about 1% by weight of the composition, that amount being sufficient to produce an isotonic or hypertonic solution and further provided that when an agent (f) is not present, the one or more optional osmotic agents, if present, is/are present in an amount sufficient to produce an isotonic solution or is/are about 0.1% to about 1% by weight of the composition, that amount being sufficient to produce an isotonic or hypertonic solution.

In a fourth aspect, the disclosure is directed to a combination of a preservative composition of the disclosure and a biological sample.

In a fifth aspect, the disclosure is directed to a method for preserving nucleic acids and/or cells in a biological sample comprising the steps of combining a preservative composition of the disclosure and the biological sample.

In a sixth aspect, the disclosure is directed to a kit for preserving nucleic acids and/or cells in a biological sample comprising:

a. a preservative composition disclosed herein; and

b. optionally, instructions for use of said preservative composition.

In a seventh aspect, the disclosure is directed to a kit for preserving nucleic acids and/or cells in a biological sample comprising:

a. a blood or other biological sample collection tube optionally containing a predetermined amount of an optional anticoagulant;

b. a syringe containing a predetermined amount of a preservative composition disclosed herein; and

c. optionally, a needle attachable to said syringe.

In an eighth aspect, the disclosure is directed to a kit for preserving nucleic acids and/or cells in a biological sample comprising:

a. a blood or other biological sample collection tube optionally containing a predetermined amount of an anticoagulant; and

b. a sealed ampule, containing a predetermined amount of a preservative disclosed herein, wherein said ampule comprises a removable closure and wherein said ampule is configured to receive a dispensing means upon removal of the closure by a user.

In some embodiments, the biological sample is derived from a bodily fluid. In some embodiments the bodily fluid is blood.

In some embodiments, the nucleic acids are cell free (“cf”) DNA. In other embodiments of the disclosure, the nucleic acids are cellular (i.e., genomic or “g”) DNA.

In some embodiments, the nucleic acids are cell free (“cf”) RNA. In other embodiments of the disclosure, the nucleic acids are cellular (i.e., genomic or “g”) RNA.

In some embodiments, the cells are stem cells, bone cells, blood cells (e.g., red blood cells and/or white blood cells), muscle cells, fat cells, skin cells, nerve cells, endothelial cells, sex cells, pancreatic cells, cancer cells, tumor cells, or circulating tumor cells. In some embodiments, the cells are lab-derived or modified cells.

### DETAILED DESCRIPTION OF THE DISCLOSURE

### Definitions

Unless otherwise defined herein, scientific and technical terms used in this application shall have the meanings that are commonly understood by those of ordinary skill in the art. In case of conflict, the present specification, including definitions, will control.

Throughout this application and its various embodiments and aspects, the word “comprise,” or variations such as “comprises” or “comprising,” will be understood to allow the inclusion of a stated integer or group of integers but not the exclusion of any other integer or group of integers.

The term “including” or “includes” is used to mean “including but not limited to.” “Including” and “including but not limited to” are used interchangeably.

Any example(s) following the term “e.g.” or “for example” is not meant to be exhaustive or limiting to this disclosure.

Unless otherwise required by context, singular terms shall include pluralities and plural terms shall include the singular.

The articles “a”, “an” and “the” are used herein to refer to one or to more than one (i.e., to at least one) of the grammatical object of the article.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10. The term “about” when used in the context of the weight percentage of a component or v/v of a mixture means +/− 10% of the recited number.

Each embodiment of this disclosure may be taken alone or in combination with one or more other embodiments of this disclosure.

Exemplary methods and materials are described herein, it should be understood that methods and materials similar or equivalent to those described herein can also be used in the practice or testing of the various aspects and embodiments. The materials, methods, and examples are illustrative only and not intended to be limiting.

In order for the disclosure to be more readily understood, certain terms are first defined. These definitions should be read in light of the remainder of the disclosure as understood by a person of ordinary skill in the art. Unless defined otherwise, all technical and scientific terms used herein have the same meaning as commonly understood by a person of ordinary skill in the art. Additional definitions are set forth throughout the detailed description.

As used herein, the term “osmotic agent” refers to an agent that produces a hypertonic or isotonic solution. Examples of osmotic agents include, but are not limited to, for example, sodium, potassium, magnesium and calcium salts, Ringer's lactate, Ringer's acetate, an amino acid, sorbitol, glycerol, mannitol, sugars such as sucrose or glucose, tartaric acid, and glucaric acid, or salts of any of them. Without wishing to be bound by theory, the one or more osmotic agents serve to alter osmotic pressure in the blood or other biological sample, leading, for example, to the release of water from the cells present in the blood or other biological sample to counteract the imbalance. This can cause, for example, the cells to shrink, thereby, making them more resistant to cell lysis which would otherwise cause the cell-free nucleic acids of the biological sample to be contaminated with cellular nucleic acids, or the cells to be less amenable to assay and analysis. Additionally, it is believed that the optional plasma expander will enhance this effect.

As used herein, the term “hypertonic solution” refers to a solution with a solute concentration that is higher than physiologic. Examples of hypertonic solutions include, but are not limited to an about 2%, 3%, 4%, 5%, 6%, 7%, 8%, 9%, 10%, 12%, 14%, 15%, 16%, 17%, 18%, 19%, 20%, 21%, 22%, 23%, 24% and 25% (by weight) NaCl solution.

As used herein, the term “isotonic solution” refers to a solution with a solute concentration that is approximately equal to physiologic. Examples of isotonic solutions include, but are not limited to an about 0.5%, 0.7%, and 1% (by weight) NaCl solution.

As used herein, the term “enzyme inhibitor” refers to an agent that, alone or in a preservative composition of this disclosure, generates complexes with metal ions, such as calcium, magnesium, manganese or zinc, to reduce blood coagulation, inhibit nucleases and/or reduce enzymatic cell lysis. Examples of enzyme inhibitors of this disclosure include but are not limited to ethylenediaminetetraacetic acid (EDTA), hydroxyethylethylenediaminetriacetic acid (HEDTA), dithiothreitol (DTT), ethylene glycol-bis(β-aminoethyl ether)-N,N,N′,N′-tetraacetic acid (EGTA), citric acid, oxalate, aurintricarboxylic acid (ATA), tartaric acid, glucaric acid, or salts of any of them, including but not limited to sodium and potassium salts. Without wishing to be bound by theory, the inhibition of nucleases will prevent or reduce the degradation of cell-free nucleic acids within the biological sample. Examples of enzymes that the enzyme inhibitor of this disclosure inhibit, include, but are not limited to lysostaphin, zymolase, protease, glycanase, or other enzymes that are known to induce cell lysis, thereby acting to preserve the cells of blood or other biological samples.

As used herein, the term “metabolic inhibitor” refers to an agent that, alone or in a preservative composition of this disclosure, inhibits cellular processes, such as cellular respiration, cellular metabolism and metabolic function, thereby reducing the degradation of cell-free nucleic acids. Without wishing to be bound by theory, the metabolic inhibitor of this disclosure is believed to slow the growth of cells by inhibiting cell metabolic functions and suppressing bacterial growth, thereby reducing degradation of cell-free nucleic acids. Examples of metabolic inhibitors of this disclosure include, but are not limited to, sodium azide, thimerosal, proclin, or chlorohexidine.

As used herein, the term “plasma expander” refers to an agent that produces a hyperoncotic or hypertonic solution. Examples of plasma expanders include, but are not limited to glycerol, starch, protein colloids (e.g., albumin, ovalbumin, and gelatins) and non-protein colloids (e.g., hydroxyethyl starch). Without wishing to be bound by theory, the optional plasma expanders of the compositions of this disclosure also serve to increase osmotic pressure in the blood plasma or other biological sample, leading to the release of water from the cells to counteract the imbalance. This causes the cells to shrink, thereby, making them more resistant to cell lysis which would otherwise cause the cell-free nucleic acids of the biological sample to be contaminated with cellular nucleic acids, or the cells to be less amenable to assay and analysis.

As used herein, the term “cell surface remodeling polymer” refers to a polymer that, when present in the amount described in the compositions of this disclosure, interacts with a cell surface (e.g., by binding to a cell surface receptor, or by reacting with specific functional groups on the cell surface) in a blood or other biological sample through covalent interactions, hydrophobic interactions or electrostatic interactions, thereby in some cases causing the cells in the blood or other biological sample to sediment. Without wishing to be bound by theory, it is believed that the sedimentation of the cells in the biological sample and/or the interactions of the cell surface and the polymer prevents or reduces cell lysis and the subsequent release of cellular nucleic acids into the sample that may otherwise contaminate, for example, the cell-free nucleic acids or intact cells within the sample. The nucleic acids and/or cells can subsequently be isolated and analyzed via conventional methods known in the art. Examples of cell surface remodeling polymers include, but are not limited to, a copolymer of N-vinylpyrollidone (NVP) and a boronic acid, an arginylglyclaspartic acid (RGD) tripeptide polymer derivative, mung bean phytohaemagglutinin, a poloxamer, and a synthetic glycopeptide that is characterized by one or more ligands for the mannose 6 phosphate receptor (e.g., glycopepties bearing multiple serine-O-mannose-6-phosphonate (M6Pn) residues). For examples of glycopeptides bearing repeated ligands for the mannose 6 phosphate receptor, see Banik, Steven; Pedram, Kayvon; Wisnovsky, Simon; Riley, Nicholas; Bertozzi, Carolyn (2019): Lysosome Targeting Chimeras (LYTACs) for the Degradation of Secreted and Membrane Proteins. ChemRxiv. Preprint. https://doi.org/10.26434/chemrxiv.7927061.v2.

As used herein, a “Ficoll” refers to a water-soluble high molecular weight sucrose polymer that is formed from the polymerization of sucrose with epichlorohydrin. For example, Ficoll 400 and Ficoll 70.

As used herein, a “poloxamer” refers to a water-soluble triblock copolymer having a central hydrophobic chain of polyoxypropylene flanked by two hydrophilic chains of polyoxyethylene. Examples of poloxamers include but are not limited to poloxamer p188 and poloxamer p407.

As used herein, a “protein colloid” refers to a mixture in which one or more proteins is dispersed in solution. Examples of protein colloids of this disclosure include, but are not limited to albumin, ovalbumin, or gelatins. The albumin may be provided as, for example, a human serum albumin (HSA), a bovine serum albumin (BSA) or an ovalbumin. Examples of gelatins include, but are not limited, to urea-linked gelatins (e.g., Haemaccel®), succinylated gelatins (e.g., Gelofusine®)), and oxypolygelatins.

As used herein, the term “a non-protein colloid” refers to a mixture in which one or more large molecules or ultramicroscopic particles are dispersed in solution. Examples of non-protein colloids include, but are not limited to, branched natural polymers of amylopectin, such as hydroxyethylated starches (HES), and polysaccharides, such as dextrans, for example, Dextran 40 and/or Dextran 70.

As used herein, a “water-soluble polymer” refers to a polymer that is soluble in aqueous solution. Examples of water-soluble polymers includes, but are not limited to a polyacrylamide, a polyacrylate, a polydextrose, a polyglycine, a polyethyleneimine, a polylysine, a polyethylene glycol, a polyvinyl pyrrolidone, a polyvinyl alcohol, a polyacrylic acid, a polymer of N-(2-hydroxypropyl) methacrylamide, a polymer of divinyl ether-maleic anhydride, a polyoxazoline, a polyphosphate, a polyphosphazene, a xanthan gum, a pectin, a chitosan derivative, a dextran, a carrageenan, a guar gum, a cellulose ether, a sodium carboxymethyl cellulose, a hydroxypropyl cellulose, a hypromellose, a hyaluronic acid, an albumin, a starch, or a starch based derivative. For further non-limiting examples of water-soluble polymers of the disclosure, see Betageri, G. V., Kadajji, V. G., Polymers, 2011, 3, pp. 1972-2009.

As used herein, the term “nucleic acid” includes both ribonucleic acid (RNA) and deoxyribonucleic acid (DNA). The RNA and/or DNA may be linear or branched, single or double stranded or fragmented. The RNA and DNA may be cellular RNA (i.e., genomic RNA), cellular DNA (i.e., genomic DNA), cell-free RNA, cell-free DNA or combinations thereof. Nucleic acids are found in biological samples, and in particular, blood samples.

As used herein, the term “biological sample” refers to a sample obtained from a biological source, including lab-derived or lab-modified cells that comprises nucleic acids and/or cells. Biological samples may be cell, culture or tissue samples. Additionally, biological samples may be derived from bodily fluids, such as, for example, blood, plasma, serum, urine, saliva, stool, breast milk, tears, sweat, cerebral spinal fluid, synovial fluid, semen, vaginal fluid, ascitic fluid, amniotic fluid, or cell culture media.

As used herein, the term “preservative” refers to a composition that is added to a biological sample that inhibits, prevents, or slows the degradation of the nucleic acids and/or cell lysis in that sample.

As used herein, the term “treated biological sample” refers to a biological sample that has been combined with a preservative composition as described in this disclosure.

As used herein, the term “cells” refers to any cell that may be found in blood or other biological samples. Types of cells include, but are not limited to stem cells, bone cells, blood cells (e.g., red blood cells or white blood cells), muscle cells, fat cells, skin cells, nerve cells, endothelial cells, sex cells, pancreatic cells, cancer cells, tumor cells, circulating tumor cells (CTCs) and lab derived and/or modified cells.

### Preservative Compositions of the Disclosure

The compositions of this disclosure are useful in the preservation and stabilization of nucleic acids and/or cells in biological samples. When the preservative compositions of the disclosure are added to a biological sample containing nucleic acids and/or cells, the degradation of the nucleic acids and/or cell lysis in that sample is reduced, slowed or prevented, as compared to untreated biological samples, allowing for the subsequent isolation and more accurate analysis of the nucleic acids and/or the cells via conventional techniques known in the art, particularly high throughput techniques. Additionally, the preservative compositions of the disclosure inhibit, slow, or reduce cell lysis, allowing the cell free nucleic acids in the sample to remain more consistent in amount and character over prolonged periods of time. The reduction of cell lysis in treated biological samples also reduces the release of nucleases, thereby further preventing or reducing degradation of nucleic acids and/or cells within the sample. The nucleic acids that can be preserved by the compositions of the disclosure include RNA, DNA or combinations thereof. The RNA and DNA can be cellular or cell-free or combinations thereof, i.e., cellular RNA, cellular DNA, cell-free RNA, cell-free DNA, or combinations thereof. Preferably, the DNA and/or RNA is cell-free DNA and/or RNA. The cells, whose lysis is reduced using the compositions and methods of this disclosure, can be, without limitation, stem cells, bone cells, blood cells, muscle cells, fat cells, skin cells, nerve cells, endothelial cells, sex cells, pancreatic cells, cancer cells, tumor cells, circulating tumor cells and lab-derived or modified cells.

In a first aspect, the disclosure is directed to a nucleic acid and cell preservative composition comprising:

a. one or more osmotic agents, the one or more osmotic agents being present in an amount sufficient to produce a hypertonic or isotonic solution;

b. one or more enzyme inhibitors;

c. optionally one or more metabolic inhibitors;

d. optionally a plasma expander; and

e. a Ficoll; wherein the composition does not comprise glycerol or mannitol.

In some embodiments of the first aspect of the disclosure, the one or more osmotic agent(s) is/are present in the preservative compositions of the disclosure in an amount of about 0.5% to about 20% by weight of the composition. In some embodiments, the osmotic agent is present in an amount of about 1% to about 15%, about 1% to about 20% or about 0.5% to about 10% by weight of the composition.

In some embodiments of the first aspect of the disclosure, the one or more osmotic agent(s) is/are present in an amount sufficient to produce a hypertonic or isotonic solution, including, but not limited to sodium, potassium, magnesium and calcium containing solutions, Ringer's lactate, Ringer's acetate, an amino acid, sorbitol, sugars such as sucrose or glucose, tartaric acid, or glucaric acid or salts of any of them.

In some embodiments of the first aspect of the disclosure, the one or more enzyme inhibitor(s) is/are present in the preservative compositions of the disclosure in an amount of about 0.5% to about 30% by weight, in some aspects in an amount of about 0.5% to about 5% by weight and in other aspects from about 1% to about 30% by weight, of the composition.

In some embodiments, the enzyme inhibitor(s) is present in an amount of about 1% to about 20% by weight of the composition. In another embodiment, the enzyme inhibitor is present in an amount of about 1% to about 10% by weight of the composition.

In some embodiments of the first aspect of the disclosure, the one or more enzyme inhibitor(s) is/are ethylenediaminetetraacetic acid (EDTA), hydroxyethylethylenediaminetriacetic acid (HEDTA), dithiothreitol (DTT), ethylene glycol-bis(β-aminoethyl ether)-N,N,N′,N′tetraacetic acid (EGTA), citric acid, oxalate, aurintricarboxylic acid (ATA), tartaric acid, glucaric acid, or salts of any of them. The salts include, but are not limited to, sodium and potassium salts or mixtures thereof.

In some embodiments of the first aspect of the disclosure, the one or more optional metabolic inhibitor(s) is/are present in the preservative compositions of the disclosure in an amount of about 0.01% to about 10% by weight of the composition. In another embodiment, the optional metabolic inhibitor is present in an amount of about 0.01% to about 5% by weight of the composition. In another embodiment, the optional metabolic inhibitor is present in an amount of about 0.01% to about 2% by weight of the composition.

In some embodiments of the first aspect of the disclosure, the one or more optional metabolic inhibitor(s) is/are sodium azide, thimerosal, proclin or chlorohexidine.

In some embodiments of the first aspect of the disclosure, the optional plasma expander is present in the preservative compositions of the disclosure in an amount of about 0.5% to about 40% by weight of the composition, such as about 0.5%, about 1%, about 10%, about 15%, about 20%, about 25%, about 30%, about 35% or about 40% by weight of the composition.

In some embodiments of the first aspect of the disclosure, the optional plasma expander is starch, protein colloids (e.g., albumin, ovalbumin, and gelatins) or non-protein colloids (e.g., hydroxyethyl starch).

Without wishing to be bound by theory, a Ficoll serves as a crowding agent, forcing cells out of solution thereby preventing or reducing cell lysis and the subsequent degradation of the cells or release of cellular nucleic acids into the sample that may otherwise contaminate, for example, the cell-free nucleic acids within the sample. The nucleic acids and/or cells can subsequently be isolated and more accurately analyzed via conventional methods known in the art.

In some embodiments of the first aspect of the disclosure, the Ficoll is present in an amount of about 10% to about 50% by weight of the composition. For example, in some embodiments, the one or more agents are present in an amount of about 10% to about 40% by weight, or from about 15% to about 35% by weight, or from about 20% to about 30% by weight of the composition.

In some embodiments of the first aspect of the disclosure, one or more components of the preservative composition of this disclosure may serve the role or function of one or more of the other components of the preservative composition. For example, tartaric acid or glucaric acid or a salt thereof may be present in the compositions of the disclosure as an enzyme inhibitor, an osmotic agent, or both.

In a second aspect, the disclosure is directed to a nucleic acid and cell preservative composition comprising:

a. one or more osmotic agents, the one or more osmotic agents being present in an amount sufficient to produce a hypertonic solution;

b. one or more enzyme inhibitors;

c. optionally one or more metabolic inhibitors;

d. optionally a plasma expander; and

e. one or more cell surface remodeling polymers.

In some embodiments of the second aspect of the disclosure, the one or more osmotic agent(s) is/are present in the preservative compositions of the disclosure in an amount of about 1% to about 30% by weight of the composition. In some embodiments, the one or more osmotic agent(s) is/are present in an amount of about 1% to about 20% by weight of the composition. In another embodiment, the one or more osmotic agent(s) is/are present in an amount of about 1% to about 10% by weight of the composition.

In some embodiments of the second aspect of the disclosure, the one or more osmotic agent(s) is/are present in an amount sufficient to produce a hypertonic solution, including, but not limited to sodium, potassium, magnesium and calcium containing solutions, Ringer's lactate, Ringer's acetate, an amino acid, sorbitol, sugars such as sucrose or glucose, tartaric acid, or glucaric acid or salts of any of them.

In some embodiments of the second aspect of the disclosure, the one or more enzyme inhibitor(s) is/are present in the preservative compositions of the disclosure in an amount of about 1% to about 30% by weight of the composition. In some embodiments, the one or more enzyme inhibitor(s) is/are present in an amount of about 1% to about 20% by weight of the composition. In another embodiment, the one or more enzyme inhibitor(s) is/are present in an amount of about 1% to about 10% by weight of the composition.

In some embodiments of the second aspect of the disclosure, the one or more enzyme inhibitor(s) is/are tartaric acid or glucaric acid.

In some embodiments of the second aspect of the disclosure, the one or more optional metabolic inhibitor(s) is/are present in the preservative compositions of the disclosure in an amount of about 0.01% to about 10% by weight of the composition. In another embodiment, the one or more optional metabolic inhibitor(s) is/are present in an amount of about 0.01% to about 5% by weight of the composition. In another embodiment, the one or more optional metabolic inhibitor(s) is/are present in an amount of about 0.01% to about 2% by weight of the composition.

In some embodiments of the second aspect of the disclosure, the one or more optional metabolic inhibitor(s) is/are thimerosal, proclin, or chlorohexidine.

In some embodiments of the second aspect of the disclosure, the optional plasma expander is present in the preservative compositions of the disclosure in an amount of about 1% to about 40% by weight of the composition, such as about 5%, about 10%, about 15%, about 20%, about 25%, about 30%, about 35% or about 40% by weight of the composition.

In some embodiments of the second aspect of the disclosure, the optional plasma expander is a starch, a protein colloid or a non-protein colloid. In some embodiments, the protein colloid is an albumin, an ovalbumin, or a gelatin. In some embodiments, the non-protein colloid is hydroxyethyl starch.

In some embodiments of the second aspect of the disclosure, the one or more cell surface remodeling polymer(s) is/are present in the compositions of the disclosure in an amount of about 10 and about 50 wt %.

In some embodiments of the second aspect of the disclosure, the one or more cell surface remodeling polymer(s) is/are selected from the group consisting of copolymer of N-vinylpyrollidone (NVP) and a boronic acid, an arginylglyclaspartic acid (RGD) tripeptide polymer derivative, mung bean phytohaemagglutinin, and a synthetic glycopeptide that bears repeated ligands for the mannose 6 phosphate receptor.

In some embodiments of the second aspect of the disclosure, the cell surface remodeling polymer is a poloxamer. In another embodiment, the cell surface remodeling polymer is poloxamer p188. In another embodiment, the cell surface remodeling polymer is poloxamer p407.

In some embodiments of the second aspect of the disclosure, one or more components of the preservative composition of this disclosure may serve the role or function of one or more of the components of the preservative composition. For example, tartaric acid or glucaric acid or a salt thereof may be present in the compositions of the disclosure as an enzyme inhibitor, an osmotic agent, or both.

In a third aspect, the disclosure is directed to a nucleic acid and cell preservative composition comprising:

a. optionally one or more osmotic agents;

b. one or more enzyme inhibitors;

c. optionally one or more metabolic inhibitors;

d. optionally a plasma expander;

e. optionally one or more cell surface remodeling polymers;

f. optionally one or more agentsselected from the group consisting of hydroxyethylstarch, a polymer of N-vinylpyrollidone (NVP), a Ficoll, a protein colloid, a non-protein synthetic colloid, ethylene diol, propylene glycol, a water-soluble polymer and carboxymethylcellulose or a salt thereof;

g. optionally polypropylene glycol (PPG); and wherein at least one cell surface remodeling polymer (e) or agent (f) is present, provided that when a cell surface remodeling polymer (e) is not present, the one or more optional osmotic agents, if present, is/are present in an amount of about 0.1% to about 1% by weight of the composition, that amount being sufficient to produce an isotonic or hypertonic solution and further provided that when an agent (f) is not present, the one or more optional osmotic agents, if present, is/are present in an amount sufficient to produce an isotonic solution or is/are about 0.1% to about 1% by weight of the composition, that amount being sufficient to produce an isotonic or hypertonic solution.

In some embodiments of the third aspect of the disclosure, the one or more optional osmotic agent(s) is/are present in the preservative compositions of the disclosure in an amount of about 0.1% to about 30% by weight of the composition. In some embodiments, the osmotic agent is present in an amount of about 0.1% to about 10%, about 1% to about 15%, about 1% to about 20% by weight of the composition. In some embodiments, the osmotic agent is present in an amount of about 0.1% to about 1% by weight of the composition. In some embodiments, no osmotic agent is present.

In some embodiments of the third aspect of the disclosure, the one or more optional osmotic agent(s) is/are present in an amount sufficient to produce an isotonic or hypertonic solution, as recited, including, but are not limited to, sodium, potassium, magnesium and calcium containing solutions, Ringer's lactate, Ringer's acetate, an amino acid, sorbitol, mannitol, sugars such as sucrose or glucose, tartaric acid, glucaric acid, or salts of any of them.

In some embodiments of the third aspect of the disclosure, the one or more enzyme inhibitor(s) is/are present in the preservative compositions of the disclosure in an amount of about 0.5% to about 30% by weight, in some aspects in an amount of about 0.5% to about 5% by weight and in other aspects from about 1% to about 30% by weight of the composition. In some embodiments, the enzyme inhibitor(s) is/are present in an amount of about 1% to about 20% by weight of the composition. In another embodiment, the enzyme inhibitor(s) is/are present in an amount of about 1% to about 10% by weight of the composition.

In some embodiments of the third aspect of the disclosure, the one or more enzyme inhibitor(s) is/are ethylenediaminetetraacetic acid (EDTA), hydroxyethylethylenediaminetriacetic acid (HEDTA), dithiothreitol (DTT), ethylene glycol-bis(β-aminoethyl ether)-N,N,N′,N′-tetraacetic acid (EGTA), citric acid, oxalate, aurintricarboxylic acid (ATA), tartaric acid, glucaric acid, or salts of any of them. The salts include, but are not limited to, sodium and potassium salts or mixtures thereof.

In some embodiments of the third aspect of the disclosure, the one or more enzyme inhibitor is ethylenediaminetetraacetic acid (EDTA) and salts thereof.

In some embodiments of the third aspect of the disclosure, the one or more optional metabolic inhibitor(s) is/are present in the preservative compositions of the disclosure in an amount of about 0.01% to about 10% by weight of the composition. In another embodiment, the optional metabolic inhibitor(s) is/are present in an amount of about 0.01% to about 5% by weight of the composition. In another embodiment, the optional metabolic inhibitor(s) is/are present in an amount of about 0.01% to about 2% by weight of the composition.

In some embodiments of the third aspect of the disclosure, the one or more optional metabolic inhibitor(s) is/are sodium azide, thimerosal, proclin or chlorohexidine.

In some embodiments of the third aspect of the disclosure, the optional plasma expander is present in the preservative compositions of the disclosure in an amount of about 0.5% to about 40% by weight of the composition, such as about 0.5%, about 1%, about 10%, about 15%, about 20%, about 25%, about 30%, about 35%, or about 40% by weight of the composition.

In some embodiments of the third aspect of the disclosure, the optional plasma expander is glycerol, a starch, a protein colloid (e.g., albumin, ovalbumin, and gelatins) or a non-protein colloid (e.g., hydroxyethyl starch). In some embodiments, the protein colloid is an albumin, an ovalbumin, or a gelatin. In some embodiments, the non-protein colloid is hydroxyethyl starch.

In some embodiments of the third aspect of the disclosure, the one or more optional cell surface remodeling polymer(s) is/are present in the compositions of the disclosure in an amount of about 10 and about 50 wt %. For example, in some embodiments, the one or more optional cell surface remodeling polymer(s) is/are present in an amount of about 10% to about 40% by weight, or from about 15% to about 35% by weight, or from about 20% to about 30% by weight of the composition.

In some embodiments of the third aspect of the disclosure, the one or more cell surface remodeling polymer(s) is/are selected from the group consisting of copolymer of N-vinylpyrollidone (NVP) and a boronic acid, an arginylglyclaspartic acid (RGD) tripeptide polymer derivative, mung bean phytohaemagglutinin, and a synthetic glycopeptide that bears repeated ligands for the mannose 6 phosphate receptor.

In some embodiments of the third aspect of the disclosure, the cell surface remodeling polymer is a poloxamer or other amphiphilic compounds that act as surfactants for the cells in blood or other biological samples. In another embodiment, the cell surface remodeling polymer is poloxamer p188. In another embodiment, the cell surface remodeling polymer is poloxamer p407.

In some embodiments of the third aspect of the disclosure, the one or more optional agent(s) is/are present in an amount of about 1% to about 50% by weight of the composition. For example, in some embodiments, the one or more optional agent(s) is/are present in an amount of about 1% to about 40% by weight, or from about 15% to about 35% by weight, or from about 20% to about 30% by weight of the composition.

In some embodiments of the third aspect of the disclosure, the one or more optional agent(s) is/are hydroxyethyl starch. In some embodiments of the third aspect of the disclosure, the one or more optional agent(s) is/are a Ficoll. In some embodiments, the Ficoll is Ficoll 400. In some embodiments of the third aspect of the disclosure, the one or more optional agent(s) is/are a protein colloid. In some embodiments, the one or more optional agent(s) is/are a non-protein colloid. In some embodiments, the one or more optional agent(s) is/are a water-soluble polymer.

In some embodiments of the third aspect of the disclosure, one or more cell surface remodeling polymer(s) is/are present and no agent(s) is/are present.

In some embodiments of the third aspect of the disclosure, one or more agent(s) is/are present and no cell surface remodeling polymer(s) is/are present.

In some embodiments of the third aspect of the disclosure, one or more agent(s) is/are present and one or more cell surface remodeling polymer(s) is/are also present.

In some embodiments of the third aspect of the disclosure, the optional polypropylene glycol (PPG) is present in an amount of about 0.1 to 10% by weight of the composition. For example, in some embodiments, the optional PPG is present in an amount of about 5% to about 10% by weight, or from about 1% to about 5% by weight, or from about 0.1% to about 1% by weight of the composition.

In some embodiments of the third aspect of the disclosure, one or more components of the preservative composition of this disclosure may serve the role or function of one or more of the components of the preservative composition. For example, tartaric acid or glucaric acid or a salt thereof may be present in the compositions of the disclosure as an enzyme inhibitor, an osmotic agent, or both. As an additional example, human serum albumin may be present in the compositions of the disclosure as a one or more agent, an optional plasma expander, or both.

The preservative compositions according to the disclosure (e.g., the first, second, and third aspects of the disclosure) can be in the form of a lyophilized powder, granules, tablets, or as a solution (e.g., wherein the preservative composition is reconstituted in a suitable vehicle). The lyophilized powder, granules and/or tablets may be added directly to the biological sample or may be reconstituted prior to being added to a biological sample. The lyophilized powder, granules, and/or tablets may, for example, be reconstituted by dissolving the composition in a suitable vehicle. Suitable vehicles include but are not limited to water, saline, Ringer's solution, fixed oils of vegetable origin, mono and diglycerides of fatty acids, ethanol, glycerin, propylene glycol, and an optional plasma expander of this disclosure. Alternatively, the biological sample may be added to the lyophilized powder, granules, tablets or the reconstituted composition (i.e., solution) directly. As another example, when the biological sample is derived from a bodily fluid, the bodily fluid can serve as an acceptable vehicle for solubilizing the preservative composition. For example, the lyophilized powder, granule, and/or tablet form of the preservative composition can be combined with the bodily fluid, thereby being solubilized by the bodily fluid. In some embodiments, the collection tube or container contains the preservative composition as a lyophilized powder, granule, tablet or solution before the biological sample is collected in the tube or container.

In some embodiments, the preservative composition of the disclosure is in the form of an aqueous solution. The aqueous solution may be combined with a biological sample or the biological sample combined with the aqueous solution.

Combinations of a Preservative Composition and a Biological Sample and Methods of Preserving Nucleic Acids and/or Cells of Biological Samples

In a fourth aspect, the disclosure is directed to a combination of a preservative composition of the disclosure and a biological sample.

In a fifth aspect, the disclosure is directed to a method for preserving nucleic acids and/or cells in a biological sample comprising the steps of combining a preservative composition of this disclosure and the biological sample.

In some embodiments of the fourth-fifth aspects, the biological sample is a cell or tissue sample.

In some embodiments of the fourth-fifth aspects, the biological sample is derived from bodily fluids. In some embodiments, the bodily fluid is blood, plasma, serum, urine, saliva, stool, breast milk, tears, sweat, cerebral spinal fluid, synovial fluid, semen, vaginal fluid, ascitic fluid, or amniotic fluid. In a preferred embodiment, the biological fluid is blood, e.g., whole blood or fractions thereof. The biological sample may include cells or may be cell-free.

In some embodiments of the fourth-fifth aspects, the biological sample comprises stem cells, bone cells, blood cells, muscle cells, fat cells, skin cells, nerve cells, endothelial cells, sex cells, pancreatic cells, cancer cells, tumor cells, or circulating tumor cells.

In some embodiments of the fourth-fifth aspects, the biological sample comprises a nucleic acid selected from RNA, DNA, or a combination thereof. In some embodiments, the nucleic acid is cell-free RNA, cell-free DNA, or a combination thereof. In some embodiments, the nucleic acid is cellular RNA, cellular DNA, or a combination thereof

The biological sample can be combined with the preservative composition of the disclosure in a number of ways. For example, the biological sample can be collected into a suitable container followed by the addition of the preservative composition to that container, e.g., by syringe or pipette. The preservative composition can alternatively be added to a suitable container for biological sample collection prior to the collection of the biological sample. In some embodiments, the preservative composition is added to a biological sample. In some embodiments, the biological sample is added to the preservative composition.

The disclosure also contemplates methods wherein the components of the preservative composition are added to the biological sample simultaneously or separately. Thus, in some embodiments, this disclosure is directed to methods of preserving nucleic acids and/or cells in a biological sample comprising contacting a biological sample with, in any order or simultaneously, the constituent components of the preservative composition of the disclosure. In some embodiments, a suitable container for the collection of the biological sample already contains one or more of the components of the preservative composition, and the remaining components are added to the biological sample, either sequentially, or simultaneously, with the biological sample being collected. For example, a blood collection tube already containing a suitable enzyme inhibitor (e.g., tartaric acid, or EDTA or its salts, or glucaric acid) may be used to collect the biological sample. Subsequent to the collection of the biological sample, the remaining components (i.e., the osmotic agent, optionally one or more of a metabolic inhibitor, an optional plasma expander, and the one or more agents) may be added to the biological sample. In another embodiment, the components of the preservative composition are added to the biological sample, either sequentially, or simultaneously, after the biological sample has been collected. In some embodiments, all of the required components of the preservative composition, and optionally the optional components, are present in the container before the container is used to collect the sample.

In some embodiments, the container to be used for sample collection contains the preservative composition in a lyophilized powder form. In some embodiments, the container to be used for sample collection contains the preservative composition in a granulate form. In some embodiments, the container to be used for sample collection contains the preservative composition in tablet form. In some embodiments, the container to be used for sample collection contains the preservative composition and a suitable vehicle. In some embodiments, the container to be used for sample collection contains the preservative composition as an aqueous solution. In another embodiment, the container to be used is for blood sample collection further comprises an anticoagulant. Examples of anticoagulants include but are not limited to EDTA (which may also function as an enzyme inhibitor), sodium citrate, citrate-theophylline-adenosine-dipyridamole (CTAD), lithium heparin, sodium heparin, sodium fluoride, acid-citrate-dextrode (ACD), and sodium polyanethol sulfonate. In some embodiments, the suitable container is an evacuated blood sample collection tube.

The amount of the preservative composition that may be combined with a biological sample can be determined by those skilled in the art through routine experimentation. In some embodiments, the ratio of the preservative composition to the biological sample may be from about 1:10 to about 1:1 v/v. In some embodiments, the ratio of the preservative composition to the biological sample is from about 1:8 to about 1:2 v/v. In some embodiments, the ratio of the preservative composition to the biological sample is from about 1:6 to about 1:3 v/v. In some embodiments, the ratio of the preservative composition to the biological sample is from about 1:5 to about 1:4 v/v.

After the biological samples have been stored, the nucleic acids and/or cells may be isolated from the biological sample for analysis using methods known to those skilled in the art including extraction, centrifugation and chromatography methods. Those skilled in the art will recognize that there are many methods that can be used to isolate the nucleic acids and/or cells from a biological sample.

Nucleic acids and/or cells that are preserved using the preservative composition of this disclosure can be isolated from treated biological samples after extended periods of storage under a variety of temperature conditions. In some embodiments, the biological sample that has been contacted with the preservative composition of this disclosure can be stored, either under ambient conditions, or low temperature for at least 1 day, at least 1 week, at least 2 weeks, at least 3 weeks or at least 4 weeks. In some embodiments, the compositions of the disclosure allow for the preservation of a biological sample (i.e., nucleic acids and/or cells in the biological sample) for extended periods of time at a temperature ranging from about −20° C. to about 30° C. In some embodiments, the preservative composition is capable of preserving a biological sample (i.e., nucleic acids and/or cells in the biological sample) for at least 1 week, at least 2 weeks, at least 3 weeks or at least 4 weeks at ambient temperature. In some embodiments the preservative composition is capable of preserving a biological sample for at least 2 weeks at ambient temperature. In some embodiments, the preservative composition of the disclosure is capable of preserving a biological sample (i.e., nucleic acids and/or cells in the biological sample) for at least 1 week, at least 2 weeks, at least 3 weeks or at least 4 weeks at 4° C. In some embodiments, the preservative composition of the disclosure is capable of preserving a biological sample (i.e., nucleic acids and/or cells in the biological sample) for at least 1 week, at least 2 weeks, at least 3 weeks or at least 4 weeks at −20° C. Nucleic acids (RNA and DNA) that are preserved using the compositions and methods of this disclosure display good yields, purity, integrity and for the RNA amplifiability.

Kits for Preserving Nucleic Acids and/or Cells in a Biological Sample

The preservative compositions according to the disclosure may be provided as part of a kit that is to be received by the user. The kit allows the preservative composition(s) of this disclosure to be readily combined with a biological sample such that the nucleic acids and/or the cells present in that biological sample are preserved for an extended period of time, e.g., at least 1 week, at least 2 weeks, at least 3 weeks or at least 4 weeks. The preservative composition can be provided such that it is combined with a biological sample after that biological sample has been collected. Alternatively, the preservative composition is provided such that it is combined with the biological sample at the time the biological sample is collected.

In some embodiments, the preservative composition is provided as an aqueous solution in a dispensing means. In some embodiments the dispensing means is a syringe. The amount of preservative in the dispensing means may be a predetermined amount such that the ratio of the preservative composition that is combined with the biological sample is capable of preserving the nucleic acids and/or cells of that sample over an extended period of time. The kit may further comprise a needle attachable to said syringe. In some embodiments, the kit is for preserving nucleic acids and/or cells in a blood sample, and further comprises a blood collection tube optionally containing a predetermined amount of an anticoagulant.

In some embodiments, the preservative composition is provided in a sealed ampule, wherein said ampule comprises a removable closure, and wherein said ampule is configured to receive a dispensing means upon removal of the closure by the user. In some embodiments, the dispensing means is a pipette or a syringe. In some embodiments, the kit is for preserving nucleic acids and/or cells in a blood sample and further comprises a blood collection tube containing a predetermined amount of an anticoagulant.

In additional embodiments, the kit is directed to preserving nucleic acids and/or cells in a blood sample and comprising a blood collection tube, optionally containing a predetermined amount of an anticoagulant, and a preservative composition of this disclosure.

In a sixth aspect, the disclosure is directed to a kit for preserving nucleic acids and/or cells in a biological sample comprising:

a. a preservative composition disclosed herein; and

b. optionally, instructions for use of said preservative composition.

In a seventh aspect, the disclosure is directed to a kit for preserving nucleic acids and/or cells in a biological sample comprising:

a. a blood or other biological sample collection tube optionally containing a predetermined amount of an optional anticoagulant;

b. a syringe containing a predetermined amount of a preservative composition disclosed herein; and

c. optionally, a needle attachable to said syringe.

In an eighth aspect, the disclosure is directed to a kit for preserving nucleic acids and/or cells in a biological sample comprising:

a. a blood or other biological sample collection tube optionally containing a predetermined amount of an anticoagulant; and

b. a sealed ampule, containing a predetermined amount of a preservative disclosed herein, wherein said ampule comprises a removable closure and wherein said ampule is configured to receive a dispensing means upon removal of the closure by a user.

In some embodiments of the sixth-eighth aspects, the biological sample is a cell or tissue sample.

In some embodiments of the sixth-eighth aspects, the biological sample is derived from a bodily fluid. In some embodiments, the bodily fluid is blood, plasma, serum, urine, saliva, stool, breast milk, tears, sweat, cerebral spinal fluid, synovial fluid, semen, vaginal fluid, ascitic fluid, or amniotic fluid. In some embodiments, the bodily fluid is whole blood or fractions thereof. The biological sample may include cells or may be cell-free.

In some embodiments of the sixth-eighth aspects, the biological sample comprises stem cells, bone cells, blood cells, muscle cells, fat cells, skin cells, nerve cells, endothelial cells, sex cells, pancreatic cells, cancer cells, tumor cells, circulating tumor cells, or a combination thereof

In some embodiments of the sixth-eighth aspects, the biological sample comprises a nucleic acid selected from RNA, DNA, or a combination thereof. In some embodiments, the nucleic acid is cell-free RNA, cell-free DNA, or a combination thereof. In some embodiments, the nucleic acid is cellular RNA, cellular DNA, or a combination thereof.

### Equivalents

The foregoing description and following examples detail certain specific embodiments of the disclosure and describe the best mode of practicing this disclosure as contemplated by the inventors. It will be appreciated, however, that no matter how detailed the foregoing may appear in text, the disclosure may be practiced in many ways and the disclosure should be construed in accordance with the appended embodiments and any equivalents thereof.

Although this disclosure has been described with reference to various applications, methods, compounds, and compositions, it will be appreciated that various changes and modifications can be made without departing from the disclosure herein. The following examples are provided to better illustrate this disclosure and are not intended to limit the scope of the teachings presented herein. While the present disclosure has been described in terms of these exemplary embodiments, the skilled artisan will readily understand that numerous variations and modifications of these exemplary embodiments are possible without undue experimentation. All such variations and modifications are within the scope of the current disclosure.

### EXAMPLES

### Example 1

### Embodiments of Preservative Compositions

Embodiments of the preservative compositions of this disclosure were prepared:

Composition 1: 2.86% by weight NaCl (osmotic agent), 0.02% by weight NaN₃ (metabolic inhibitor), 0.75% by weight 2Na-EDTA and 0.75% by weight 4Na-EDTA (enzyme inhibitors), 20.0% by weight Ficoll PM400 (agent), and the balance water.

Composition 2: 2.86% by weight NaCl (osmotic agent), 0.02% by weight NaN₃ (metabolic inhibitor), 0.75% by weight 2Na-EDTA and 0.75% by weight 4Na-EDTA (enzyme inhibitors), 20.0% by weight poloxamer p188 (cell surface remodeling polymer), and the balance water.

### Example 2

### Analysis of Plasma Volume

Blood samples from various donors are collected into blood sample collection tubes to assess the plasma volume of samples treated with a preservative composition according to this disclosure. The preservative compositions of Example 1 are tested by adding the blood sample into a tube containing 2 mL of the preservative composition.

The combined preservative composition and blood sample is then centrifuged for ˜15 minutes at room temperature and 425 g, resulting in the formation of a pellet in the collection tube. Next, without disturbing the separated components, the upper plasma layer (supernatant) is transferred to a separate collection tube using a pipette. The transferred supernatant is then centrifuged again for ˜15 minutes at 4° C. and at 16,000 g to remove any inadvertently transferred cell debris or precipitate and the volume of residual plasma is measured. The measured volume is referred to herein as the “plasma volume”.

Without wishing to be bound by theory, the “plasma volume” is expected to be an important factor in facilitating the use of the aspects of the present disclosure in high-throughput applications. The use of automation and robotics in those applications necessitates consistent plasma volumes, ideally between 3-6 mL.

The “plasma volume” of mixtures that were processed according to the above procedure and preserved in tubes containing composition 1 were observed to be 6-6.2 mL.

The “plasma volume” of mixtures that were processed according to the present procedure and preserved in tubes containing composition 2 were observed to be 2.2-3.7 mL.

### Example 3

### Analysis of the Integrity of the Isolated CfDNA and RNA

Blood samples from various donors are collected into the blood sample collection tubes to assess the ability of embodiments of the preservative compositions of this disclosure to preserve cfDNA and RNA. The preservative compositions of Example 1 are tested by adding the blood sample into a tube containing 2 mL of the preservative composition.

The cfDNA and RNA are isolated from the samples using extraction and separation techniques known in the art. One such cfDNA extraction method involves using a MagMAX™ Cell-Free DNA Isolation Kit. One such RNA extraction method involves using a procedure based on Beckman Coulter's RNAdvance Blood Kit.

The isolated cfDNA and RNA is analyzed at Day 1, the blood being drawn on Day 0. The integrity of the nucleic acids is analyzed to assess the characteristics of the preservative compositions.

### CfDNA Integrity

The integrity of the cfDNA is analyzed by qPCR of long and short DNA fragments and characterized by the ratio of long fragment over short fragment (222 bp/90 bp). The obtained ratio is referred to herein as the DNA Integrity Number (DIN). DIN is an objective metric of cfDNA quality When the DIN is <0.5, the cfDNA is considered to be pure (i.e., the plasma is not contaminated by gDNA (cellular or genomic DNA)).

A 10-fold dilution series of the gDNA (1 ng/μL to 0.01 ng/μL) is prepared for a standard curve. A forward and reverse primer mix is prepared at 5 μM concentration by mixing 5 μL of 100 μM forward primer, 5 μL of 100 μM reverse primer with 90 μL of nuclease-free water.

Two separate mixtures are prepared with 1 μL of standard or cfDNA sample, respectively, and 8 μL of nuclease-free water for 1 reaction in mixture #1 and 1 μL of primer mixture and 10 μL of 2× PowerTrack SYBR Green Master Mix (ThermoFisher Scientific) for 1 reaction in mixture #2. 90 μL of mixture #1 and 11 μL of mixture #2 are added to the wells of a 96-well optical plate to run the real-time PCR. The thermal cycling conditions are set forth in the table below.

DNA Thermal Profile

| | | | | |
|---|---|---|---|---|
| Cycle 1 | 95° C. | 10 | min | 1X |
| Cycle 2 | 95° C. | 15 | s | 40X |
| | 62° C. | 30 | s | |

| | |
|---|---|
| Melting analysis | 1X |

### RNA Integrity

The integrity of RNA from the samples is analyzed by BioAnalyzer using agarose gel electrophoresis and characterized by RNA integrity number (RIN). RIN is an objective metric of total RNA quality ranging from 10 (highly intact RNA) to 1 (completely degraded RNA).

The Properties of the cfDNA in Blood Samples Preserved Using the Compositions of Example 1:

The integrity of cfDNA extracted from blood samples (i.e., the DIN) that are preserved in tubes containing either composition 1 or 2 is generally high, as the ratio of long fragment over short fragment (222 bp/90 bp) from the qPCR assay is observed to be in a range of <0.1 to 0.7.

The Properties of the RNA in Blood Samples Preserved Using the Compositions of Example 1:

The RIN of the RNA isolated from blood samples that are preserved in tubes containing either composition 1 or 2 is generally high, as they were observed to have a RIN in a range of 7.4 to 9.1.

We claim:

1. A preservative composition comprising:
a. one or more osmotic agents, the one or more osmotic agents being present in an amount sufficient to produce a hypertonic or isotonic solution;
b. one or more enzyme inhibitors;
c. optionally one or more metabolic inhibitors;
d. optionally a plasma expander; and
e. a Ficoll;
wherein the composition does not include glycerol or mannitol.

2. The preservative composition according to claim 1, wherein the one or more osmotic agent(s) is/are present in the preservative compositions in an amount of about 0.5% to about 20% by weight of the composition.

3. The preservative composition according to claim 1, wherein the one or more osmotic agent(s) is/are present in an amount sufficient to produce a hypertonic or isotonic salt solution, including, but not limited to sodium, potassium, magnesium and calcium containing solutions, Ringer's lactate, Ringer's acetate, an amino acid, sorbitol, sugars such as sucrose or glucose, tartaric acid, or glucaric acid, or a salt thereof

4. The preservative composition according to claim 1, wherein the one or more enzyme inhibitor(s) is/are ethylenediaminetetraacetic acid (EDTA), hydroxyethylethylenediaminetriacetic acid (HEDTA), dithiothreitol (DTT), ethylene glycol-bis(β-aminoethyl ether)-N,N,N′,N′-tetraacetic acid (EGTA), citric acid, oxalate, aurintricarboxylic acid (ATA), tartaric acid, glucaric acid, or salts of any of them.

5. The preservative composition according to claim 1, wherein enzyme inhibitor is ethylenediaminetetraacetic acid (EDTA) or salts thereof.

6. The preservative composition according to claim 1, wherein the one or more optional metabolic inhibitor(s) is/are sodium azide, thimerosal, proclin or chlorohexidine.

7. The preservative composition according to claim 1, wherein the optional plasma expander is a starch, a protein colloid or a non-protein colloid.

8. The preservative composition according to claim 7, wherein the protein colloid is an albumin, an ovalbumin, or a gelatin.

9. The preservative composition according to claim 7, wherein the non-protein colloid is hydroxyethyl starch.

10. The preservative composition according to claim 1, wherein the Ficoll is present in an amount of from about 10% to about 50% by weight of the composition.

11. The preservative composition according to claim 10, wherein the Ficoll is present in an amount of from about 20% to about 30% by weight of the composition.

12. The preservative composition according to claim 1, wherein the Ficoll is Ficoll 400.

13. A preservative composition comprising:
a. one or more osmotic agents, the one or more osmotic agents being present in an amount sufficient to produce a hypertonic solution;
b. one or more enzyme inhibitors;
c. optionally one or more metabolic inhibitors;
d. optionally a plasma expander; and
e. one or more cell surface remodeling polymers.

14. The preservative composition according to claim 13, wherein the one or more osmotic agent(s) is/are present in the preservative compositions in an amount of about 1% to about 30% by weight of the composition.

15. The preservative composition according to claim 13, wherein the one or more osmotic agent(s) is/are present in an amount sufficient to produce a hypertonic solution, including, but not limited to sodium, potassium, magnesium and calcium containing solutions, Ringer's lactate, Ringer's acetate, an amino acid, sorbitol, glycerol, mannitol, sucrose, tartaric acid or a salt thereof, or glucaric acid or salts of any of them.

16. The preservative composition according to claim 13, wherein the one or more enzyme inhibitor(s) is/are present in the preservative compositions in an amount of about 1% to about 30% by weight of the composition.

17. The preservative composition according to claim 13, wherein the one or more enzyme inhibitor(s) is/are tartaric acid or glucaric acid.

18. The preservative composition according to claim 13, wherein the one or more optional metabolic inhibitor(s) is/are thimerosal, proclin, or chlorohexidine.

19. The preservative composition according to claim 13, wherein the optional plasma expander is a starch, a protein colloid or a non-protein colloid.

20. The preservative composition according to claim 13, wherein the one or more cell surface remodeling polymer(s) is/are present in the preservative composition in an amount of about 10% to about 50% by weight of the composition.

21. The preservative composition according to claim 13, wherein the one or more cell surface remodeling polymer(s) is/are selected from the group consisting of a copolymer of N-vinylpyrollidone (NVP) and a boronic acid, an arginylglyclaspartic acid (RGD) tripeptide polymer derivative, mung bean phytohaemagglutinin, and a synthetic glycopeptide that bears repeated ligands for the mannose 6 phosphate receptor.

22. The preservative composition according to claim 13, wherein the cell surface remodeling polymer is a poloxamer.

23. The preservative composition according to claim 22, wherein the poloxamer is poloxamer p188.

24. The preservative composition according to claim 22, wherein the poloxamer is poloxamer p407.

25. A preservative composition comprising:
a. optionally one or more osmotic agents;
b. one or more enzyme inhibitors;
c. optionally one or more metabolic inhibitors;
d. optionally a plasma expander;
e. optionally one or more cell surface remodeling polymers;
f. optionally one or more agents selected from the group consisting of hydroxyethylstarch, a polymer of N-vinylpyrollidone (NVP), a Ficoll, a protein colloid, a non-protein synthetic colloid, ethylene diol, propylene glycol, a water-soluble polymer and carboxymethylcellulose or a salt thereof; and
g. optionally polypropylene glycol (PPG);
wherein at least one cell surface remodeling polymer (e) or agent (f) is present, provided that when a cell surface remodeling polymer (e) is not present, the one or more optional osmotic agents, if present, is/are present in an amount of about 0.1% to about 1% by weight of the composition, that amount being sufficient to produce an isotonic or hypertonic solution and further provided that when an agent (f) is not present, the one or more optional osmotic agents, if present, is/are present in an amount sufficient to produce an isotonic solution or is/are about 0.1% to about 1% by weight of the composition, that amount being sufficient to produce an isotonic or hypertonic solution.

26. The preservative composition according to claim 25, wherein the one or more optional osmotic agent(s) is/are present in the preservative composition in an amount of about 0.1% to about 30% by weight of the composition.

27. The preservative composition according to claim 26, wherein the one or more optional osmotic agent(s) is/are present in the preservative composition in an amount of about 0.1% to about 1% by weight of the composition.

28. The preservative composition according to claim 25, wherein no osmotic agent is present.

29. The preservative composition according to claim 25, wherein the one or more optional osmotic agent(s) is/are present in an amount sufficient to produce an isotonic, hypertonic or hyperotonic solution, as recited, including, but not limited to sodium, potassium, magnesium or calcium containing solutions, Ringer's lactate, Ringer's acetate, an amino acid, sorbitol, mannitol, sugars such as sucrose or glucose, tartaric acid, glucaric acid, or salts of any of them.

30. The preservative composition according to claim 25, wherein the one or more enzyme inhibitor(s) is/are present in the preservative compositions in an amount of about 0.5% to about 30% by weight of the composition.

31. The preservative composition according to claim 25, wherein the one or more enzyme inhibitor(s) is/are ethylenediaminetetraacetic acid (EDTA), hydroxyethylethylenediaminetriacetic acid (HEDTA), dithiothreitol (DTT), ethylene glycol-bis(β-aminoethyl ether)-N,N,N′,N′-tetraacetic acid (EGTA), citric acid, oxalate, aurintricarboxylic acid (ATA), tartaric acid, or glucaric acid, or a salt of any of them.

32. The preservative composition according to claim 31, wherein the enzyme inhibitor is ethylenediaminetetraacetic acid (EDTA) and salts thereof.

33. The preservative composition according to claim 25, wherein the one or more optional metabolic inhibitor(s) is/are sodium azide, thimerosal, proclin or chlorohexidine.

34. The preservative composition according to claim 25, wherein the optional plasma expander is glycerol, a starch, a protein colloid or a non-protein colloid.

35. The preservative composition according to claim 34, wherein the protein colloid is an albumin, an ovalbumin, or a gelatin.

36. The preservative composition according to claim 34, wherein the non-protein colloid is hydroxyethyl starch.

37. The preservative composition according to claim 25, wherein the one or more optional cell surface remodeling polymer(s) is/are selected from the group consisting of copolymer of N-vinylpyrollidone (NVP) and a boronic acid, an arginylglyclaspartic acid (RGD) tripeptide polymer derivative, mung bean phytohaemagglutinin, and a synthetic glycopeptide that bears repeated ligands for the mannose 6 phosphate receptor.

38. The preservative composition according to claim 25, wherein the optional cell surface remodeling polymer is a poloxamer.

39. The preservative composition according to claim 38, wherein the poloxamer is poloxamer p188.

40. The preservative composition according to claim 38, wherein the poloxamer is poloxamer p407.

41. The preservative composition according to claim 25, wherein the one or more optional agent(s) is/are present in an amount of about 10% to about 50% by weight of the composition.

42. The preservative composition according to claim 25, wherein the optional agent is hydroxyethyl starch.

43. The preservative composition according to claim 25, wherein the one or more optional agent(s) is/are a Ficoll.

44. The preservative composition according to claim 43, wherein the Ficoll is Ficoll 400.

45. The preservative composition according to claim 25, wherein one or more cell surface remodeling polymer(s) is/are present, and no agent(s) is/are present.

46. The preservative composition according to claim 25, wherein one or more agent(s) is/are present, and no cell surface remodeling polymer(s) is/are present.

47. The preservative composition according to claim 25, wherein one or more agent(s) is/are present, and one or more cell surface remodeling polymer(s) is/are also present.

48. The preservative composition according to claim 25, wherein the optional polypropylene glycol (PPG) is present in an amount of about 0.1% to about 10% by weight of the composition.

49. A combination of a preservative composition according to any one of claims 1-48 and a biological sample.

50. The combination according to claim 49, wherein the biological sample is a cell or tissue sample.

51. The combination according to claim 49, wherein the biological sample is derived from bodily fluids.

52. The combination according to claim 51, wherein the bodily fluid is blood (e.g., whole blood or fractions thereof).

53. The combination according to claim 49, wherein the biological sample comprises stem cells, bone cells, blood cells, muscle cells, fat cells, skin cells, nerve cells, endothelial cells, sex cells, pancreatic cells, cancer cells, tumor cells, or circulating tumor cells.

54. The combination according to claim 49, wherein the biological sample comprises a nucleic acid selected from RNA, DNA, or a combination thereof.

55. The combination according to claim 54, wherein the nucleic acid is cell-free RNA, cell-free DNA, or a combination thereof.

56. The combination according to claim 54, wherein the nucleic acid is cellular RNA, cellular DNA, or a combination thereof.

57. The combination according to any one of claims 49-56, wherein the ratio of the preservative composition to the biological sample is from about 1:10 to about 1:1 v/v.

58. The combination according to claim 57, wherein the ration of the preservative composition to the biological sample is from about 1:5 to about 1:4 v/v.

59. The combination according to any one of claims 49-58, wherein the composition is capable of preserving the nucleic acids and/or cells in a biological sample for at least 2 weeks at ambient temperature.

60. A method for preserving nucleic acids and/or cells in a biological sample comprising the steps of combining a preservative composition according to any one of claims 1-48 and the biological sample.

61. The method according to claim 60, wherein the biological sample is a cell or tissue sample.

62. The method according to claim 60, wherein the biological sample is derived from bodily fluids.

63. The method according to claim 62, wherein the bodily fluid is blood (e.g., whole blood or fractions thereof).

64. The method according to claim 60, wherein the biological sample comprises stem cells, bone cells, blood cells, muscle cells, fat cells, skin cells, nerve cells, endothelial cells, sex cells, pancreatic cells, cancer cells, tumor cells, or circulating tumor cells.

65. The method according to claim 60, wherein the biological sample comprises a nucleic acid selected from RNA, DNA, or a combination thereof.

66. The method according to claim 65, wherein the nucleic acid is cell-free RNA, cell-free DNA, or a combination thereof.

67. The method according to claim 65, wherein the nucleic acid is cellular RNA, cellular DNA, or a combination thereof

68. The method according to any one of claims 60-67, wherein the ratio of the preservative composition to the biological sample is from about 1:10 to about 1:1 v/v.

69. The method according to claim 68, wherein the ration of the preservative composition to the biological sample is from about 1:5 to about 1:4 v/v.

70. A kit for preserving nucleic acids and/or cells in a biological sample comprising:
a. a preservative composition according to any one of claims 1-48; and
b. optionally, instructions for use of said preservative composition.

71. The kit according to claim 70, wherein the biological sample is a cell or tissue sample.

72. The kit according to claim 70, wherein the biological sample is derived from a bodily fluid.

73. The kit according to claim 70, wherein the bodily fluid is blood (e.g., whole blood or fractions thereof).

74. The kit according to claim 70, wherein the biological sample comprises stem cells, bone cells, blood cells, muscle cells, fat cells, skin cells, nerve cells, endothelial cells, sex cells, pancreatic cells, cancer cells, tumor cells, circulating tumor cells, or a combination thereof.

75. The kit according to claim 70, wherein the biological sample comprises a nucleic acid selected from RNA, DNA, or a combination thereof.

76. The kit according to claim 75, wherein the nucleic acid is cell-free RNA, cell-free DNA, or a combination thereof.

77. The kit according to claim 75, wherein the nucleic acid is cellular RNA, cellular DNA, or a combination thereof.

78. A kit for preserving nucleic acids and/or cells in a biological sample comprising:
a. a blood or other biological sample collection tube optionally containing a predetermined amount of an optional anticoagulant;
b. a syringe containing a predetermined amount of a preservative composition according to any one of claims 1-48; and
c. optionally, a needle attachable to said syringe.

79. The kit according to claim 78, wherein the biological sample is a cell or tissue sample.

80. The kit according to claim 78, wherein the biological sample is derived from a bodily fluid.

81. The kit according to claim 78, wherein the bodily fluid is blood (e.g., whole blood or fractions thereof).

82. The kit according to claim 78, wherein the biological sample comprises stem cells, bone cells, blood cells, muscle cells, fat cells, skin cells, nerve cells, endothelial cells, sex cells, pancreatic cells, cancer cells, tumor cells, circulating tumor cells, or a combination thereof.

83. The kit according to claim 78, wherein the biological sample comprises a nucleic acid selected from RNA, DNA, or a combination thereof.

84. The kit according to claim 83, wherein the nucleic acid is cell-free RNA, cell-free DNA, or a combination thereof.

85. The kit according to claim 83, wherein the nucleic acid is cellular RNA, cellular DNA, or a combination thereof.

86. A kit for preserving nucleic acids and/or cells in a biological sample comprising:
a. a blood or other biological sample collection tube optionally containing a predetermined amount of an anticoagulant; and
b. a sealed ampule, containing a predetermined amount of a preservative composition according to any one of claims 1-48, wherein said ampule comprises a removable closure and wherein said ampule is configured to receive a dispensing means upon removal of the closure by a user.

87. The kit according to claim 86, wherein the biological sample is a cell or tissue sample.

88. The kit according to claim 86, wherein the biological sample is derived from a bodily fluid.

89. The kit according to claim 88, wherein the bodily fluid is blood (e.g., whole blood or fractions thereof).

90. The kit according to claim 86, wherein the biological sample comprises stem cells, bone cells, blood cells, muscle cells, fat cells, skin cells, nerve cells, endothelial cells, sex cells, pancreatic cells, cancer cells, tumor cells, circulating tumor cells, or a combination thereof.

91. The kit according to claim 86, wherein the biological sample comprises a nucleic acid selected from RNA, DNA, or a combination thereof.

92. The kit according to claim 91, wherein the nucleic acid is cell-free RNA, cell-free DNA, or a combination thereof.

93. The kit according to claim 91, wherein the nucleic acid is cellular RNA, cellular DNA, or a combination thereof.
